(19) United States
(12) Patent Application Publication
(10) Pub. No.: US 2012/0220253 A1
(43) Pub. Date: Aug. 30, 2012

(54) WIRELESS COMMUNICATIONS APPARATUS AND FREQUENCY-CHARACTERISTIC COMPENSATING APPARATUS

(75) Inventor: Jun Kameya, Kawasaki (JP)

(73) Assignee: FUJITSU LIMITED, Kawasaki-shi (JP)

(21) Appl. No.: 13/294,440

(22) Filed: Nov. 11, 2011

(30) Foreign Application Priority Data
Feb. 25, 2011 (JP) 2011-040416

(51) Int. Cl. H04B 1/12

(52) U.S. Cl. 455/295

(57) ABSTRACT

A wireless communications apparatus includes a setup-value storage storing therein setup information that includes a compensation coefficient that is used in frequency-characteristic compensation of a subcarrier signal that results from separating frequency components from a multicarrier modulated signal, an operation category indicating the type of handling of the compensation coefficient, and a category condition; a subcarrier-signal input unit that receives input of the subcarrier signal; an address generator that in conjunction with the input timing of the subcarrier signal, generates an address that corresponds to the subcarrier signal; an operation category selector that determines a category condition that the generated address satisfies, and selects the operation category that corresponds to the category condition; frequency-characteristic compensating unit uses the compensation coefficient that corresponds to the selected operation category and performs the frequency-characteristic compensation on the input subcarrier signal; and an output unit that outputs the frequency-characteristic compensated signal.

### CROSS REFERENCE TO RELATED APPLICATIONS

This application is based upon and claims the benefit of priority of the prior Japanese Patent Application No. 2011-040416, filed on Feb. 25, 2011, the entire contents of which are incorporated herein by reference.

### FIELD

The embodiments discussed herein are related to compensation of a frequency characteristic.

### BACKGROUND

Conventionally, in wireless communications apparatuses, a method may be adopted where an address, for which the power of an input signal has been converted, is converted into a table index address and depending on the results of comparison of the occurrence frequency of the table index address and a threshold, the number of addresses corresponding to a table index address varies, whereby the characteristic of distortion compensation is improved. Another method among serial-type predistortion schemes of compensating distortion, involves compensating a distorted component through few computations, by using the magnitude of distortion of the distorted component at 3 or more phase values or amplitude values set for sampling, to obtain by functional approximation, the phase value or the amplitude value at which the distorted component becomes smallest. Further, a wireless communications apparatus is available that includes a reconfigurable module that compensates frequency variations of digitally modulated signals that have been received. There is also a method that based on the reception level ratio of 2 frequencies, selectively changes the upstream band control filter of a demodulator to correct the frequency characteristic through minimal processing. Another method performs a two-register shift operation to detect the periodicity of bit data demodulated from a received signal that has been subject to channel-characteristic compensation, and further selectively suspends operation that optimizes the compensation characteristic according to the periodicity to properly perform data modulation. For examples of the conventional technologies, see Japanese Laid-Open Patent Publication Nos. 2007-49251, 2010-93785, 2007-74423, 2007-195204, and H6-326634.

However, with conventional technologies above, a compensation coefficient for compensating subcarrier signals that result from separating frequency components from a multicarrier modulation signal is stored to memory, for each subcarrier. Consequently, power is continuously consumed by the memory, arising in a problem of high power consumption. For example, when the frequency characteristic in a frequency band that is to be used is constant, at all of the addresses of the memory, a frequency-characteristic compensation coefficient of the same value is stored, resulting in inefficient memory utilization and wasteful power consumption by the memory.

### SUMMARY

According to an aspect of an embodiment, a wireless communications apparatus performs frequency-characteristic compensation with respect to a subcarrier signal that results from separating frequency components from a multicarrier modulated signal. The wireless communications apparatus includes a setup-value storage that stores therein setup information that includes a compensation coefficient that is used in the frequency-characteristic compensation of the subcarrier signal, an operation category indicating the type of handling of the compensation coefficient in the frequency-characteristic compensation, and a category condition used in determining whether to select the operation category in the frequency-characteristic compensation; a subcarrier-signal input unit that receives input of the subcarrier signal; an address generator that in conjunction with the input timing of the subcarrier signal, generates an address that corresponds to the subcarrier signal; an operation category selector that determines a category condition, which is a condition that the generated address satisfies, and selects the operation category that corresponds to the category condition; a frequency-characteristic compensating unit uses the compensation coefficient that corresponds to the selected operation category in a frequency-characteristic compensation process for the selected operation category and performs the frequency-characteristic compensation on the input subcarrier signal; and an output unit that outputs the frequency-characteristic compensated signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a wireless communications apparatus according to a first embodiment.

FIG. 2 is a diagram of an overview of compensation of the frequency characteristic.

FIG. 3 is a block diagram of the wireless communications apparatus according to a second embodiment.

FIG. 4 is a block diagram of a transmission processor of the wireless communications apparatus according to the second embodiment.

FIG. 5 is a block diagram of a frequency-characteristic compensating unit of the wireless communications apparatus according to the second embodiment.

FIG. 6 is a block diagram of a controller of the wireless communications apparatus according to the second embodiment.

FIG. 7 is a diagram of a setup-value storage register of the wireless communications apparatus according to the second embodiment.

FIG. 8 is a block diagram of a compensation coefficient generator of the wireless communications apparatus according to the second embodiment.

FIGS. 9 and 10 are flowcharts of a process performed by the frequency-characteristic compensating unit of the wireless communications apparatus according to the second embodiment.

FIG. 11 is a diagram of an example of frequency-characteristic compensation coefficients for subcarriers.

FIG. 12 is a diagram of an example of the setup-value storage register corresponding to the example depicted in FIG. 11.

### DESCRIPTION OF EMBODIMENTS

Preferred embodiments of the present invention will be explained with reference to the accompanying drawings. A wireless communications apparatus and a frequency-characteristic compensating apparatus store to setup-value storage, setup information that includes compensation coefficients, operation categories, and category conditions; selects an operation category that corresponds to a category condition, which is a condition that the address corresponding to an input subcarrier signal satisfies; and uses a compensation coefficient that corresponds to the operation category to compensate the frequency characteristic of a the subcarrier signal. In the description of the embodiments similar components are given the same reference numerals and redundant description is omitted.

The wireless communications apparatus includes a frequency-characteristic compensating apparatus. The frequency-characteristic compensating apparatus compensates the frequency characteristic of subcarrier signals that result from separating frequency components from a multicarrier modulated signal.

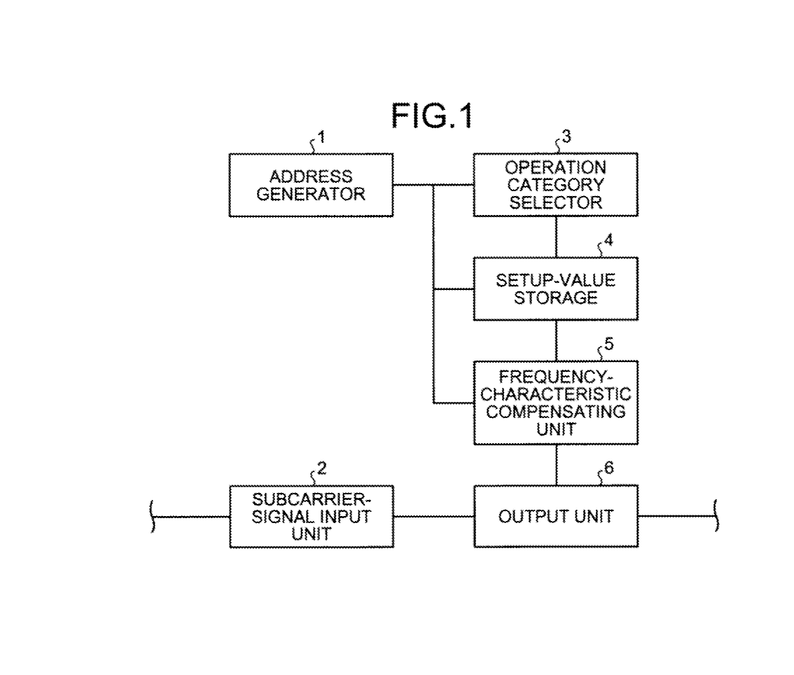

FIG. 1 is a block diagram of the wireless communications apparatus according to a first embodiment. as depicted in FIG. 1, the wireless communications apparatus includes, as the frequency-characteristic compensating apparatus, for example, an address generator 1, a subcarrier-signal input unit 2, an operation category selector 3, a setup-value storage 4, a frequency-characteristic compensating unit 5, and an output unit 6.

The setup-value storage 4 stores setup information that includes compensation coefficients, operation categories, and category conditions. A compensation coefficient is used in the compensation of the frequency characteristic of a subcarrier signal. An operation category indicates the type of handling of the compensation coefficient in the compensation of the frequency characteristic. A category condition is used in determining whether to select an operation category during the compensation of the frequency characteristic.

The subcarrier-signal input unit 2 receives the input of a subcarrier signal. The address generator 1, in conjunction with the input timing of the subcarrier signal, generates an address that corresponds to the subcarrier signal. The operation category selector 3 determines a category condition, which is a condition that the generated address satisfies, and selects an operation category that corresponds to the category condition. The frequency-characteristic compensating unit 5, in a frequency-characteristic compensation process for the selected operation category, uses a compensation coefficient that corresponds to the selected operation category and compensates the frequency-characteristic of the input subcarrier signal. The output unit 6 outputs the frequency-characteristic compensated signal.

In the first embodiment, according to the operation category, a compensation coefficient is acquired from the setup-value storage 4, and the acquired compensation coefficient is used to compensate the frequency characteristic of the subcarrier signal. Therefore, compared to a case where a compensation coefficient for each subcarrier is held in memory and a compensation coefficient is readout for each subcarrier signal to compensate the frequency characteristic, power consumption by the memory can be reduced. Accordingly, the power consumption of the wireless communications apparatus can be reduced.

In the wireless communications apparatuses, transmission power variations may occur consequent to the frequency characteristic of the wireless unit device. Some wireless communications apparatuses compensate the transmission power variations by compensating the signal at a digital baseband unit, before outputting the signal to the wireless unit. In other words, the frequency characteristic of the wireless unit device is compensated at the digital baseband unit.

For example, in a wireless communications apparatus used in Orthogonal Frequency Division Multiplexing (OFDM), an uplink (from terminal to base station) baseband processor maps the transmission signal on a subcarrier according to frequency domains. Consequently, under OFDM, signals in the frequency domains can be easily compensated. Without limitation to OFDM, provided transmission signals are mapped to subcarriers according to frequency domain, signals in the frequency domains can be easily compensated. Accordingly, even if transmission signals of a time domain are mapped to subcarriers after first being converted to frequency domain signals, signal compensation can easily performed at the frequency domains.

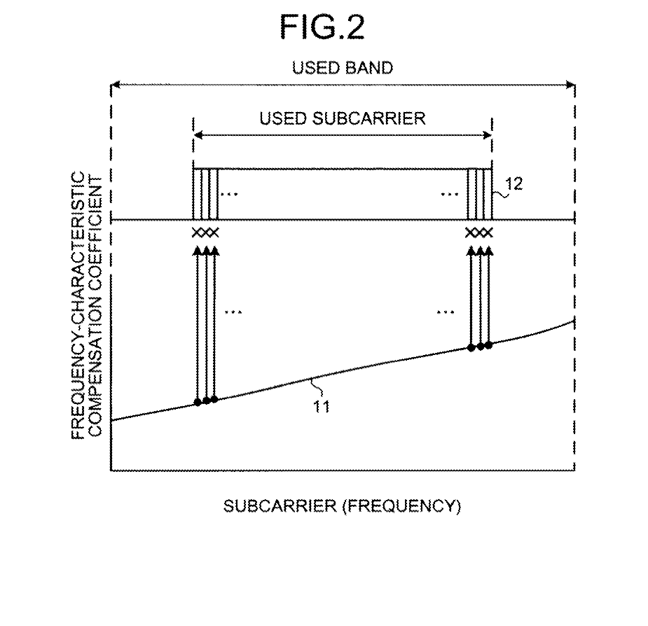

FIG. 2 is a diagram of an overview of compensation of the frequency characteristic. As depicted in FIG. 2, the baseband processor, for example, calculates a frequency-characteristic compensation coefficient 11 for each subcarrier corresponding to the frequency band used. Further, for example, the baseband processor maps a transmission signal to a subcarrier 12 used in the used frequency band and multiplies each subcarrier 12 by the frequency-characteristic compensation coefficient 11 corresponding to the subcarrier 12. In FIG. 2, “” along the frequency-characteristic compensation coefficient 11 curve represent coefficients, and “×” pointed to by arrows extending from each of the frequency-characteristic compensation coefficient 11 indicate multiplication of the frequency-characteristic compensation coefficient 11 and the subcarrier 12.

A base station or a terminal in a wireless communications system, such as a mobile telephone system, may be given an example of the wireless communications apparatus. A mobile telephone may be given as an example of the terminal. Further, for example, Orthogonal Frequency Division Multiple Access (OFDMA), Code Division Multiple Access (CDMA) may be given as examples of the wireless communications scheme and for example, Long Term Evolution (LTE), i.e., 3.9G may be given as an example of the mobile telephone system.

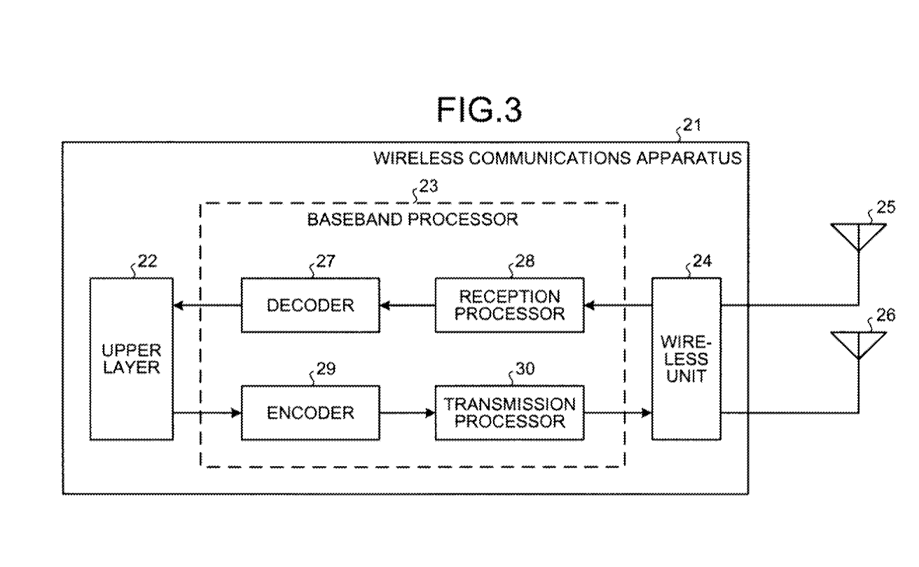

FIG. 3 is a block diagram of the wireless communications apparatus according to a second embodiment. As depicted in FIG. 3, a wireless communications apparatus 21 includes an upper layer 22, a baseband processor 23, a wireless unit 24, a receiving antenna 25, and a transmitting antenna 26. The upper layer 22 controls application execution, and lower layers such as the baseband processor 23 and the wireless unit 24. The baseband processor 23 processes baseband signals. The baseband processor 23 includes a decoder 27, a reception processor 28, an encoder 29, and a transmission processor 30.

The encoder 29 encodes data output from the upper layer 22. The transmission processor 30 generates transmission data from the encoded data output by the encoder 29. The transmission processor 30 maps to a subcarrier, the data output by the encoder 29 and converts the mapped data to a time domain signal. The transmission processor 30 will be described in detail hereinafter. The wireless unit 24 transmits from the transmitting antenna 26, the data output by the transmission processor 30. The wireless unit 24 receives via the receiving antenna 25, a wireless signal. The reception processor 28 performs reception processes on the signal output by the wireless unit 24. The decoder 27 decodes the signal output by the reception processor 28 and forwards reception data to the upper layer 22. The wireless unit 24 includes a duplexer; and the receiving antenna and the transmitting antenna may be implemented by a common antenna.

A transmission processor of an LTE uplink baseband processor may be given as an example of the transmission processor. Under LTE, a Physical Uplink Shared Channel (PUSCH) signal, a Physical Uplink Control Channel (PUCCH) signal, a Demodulation Reference Signal (DRS), a Sounding Reference Signal (SRS), and a Physical Random Access Channel (PRACH) signal are transmitted from a terminal to a base station. Each of these signals has the potential of being subject to frequency-characteristic compensation at the frequency domains.

In the second embodiment, transmission processes for PUSCH, PUCCH, DRS, and SRS will be described. Description of the PRACH transmission process will be omitted.

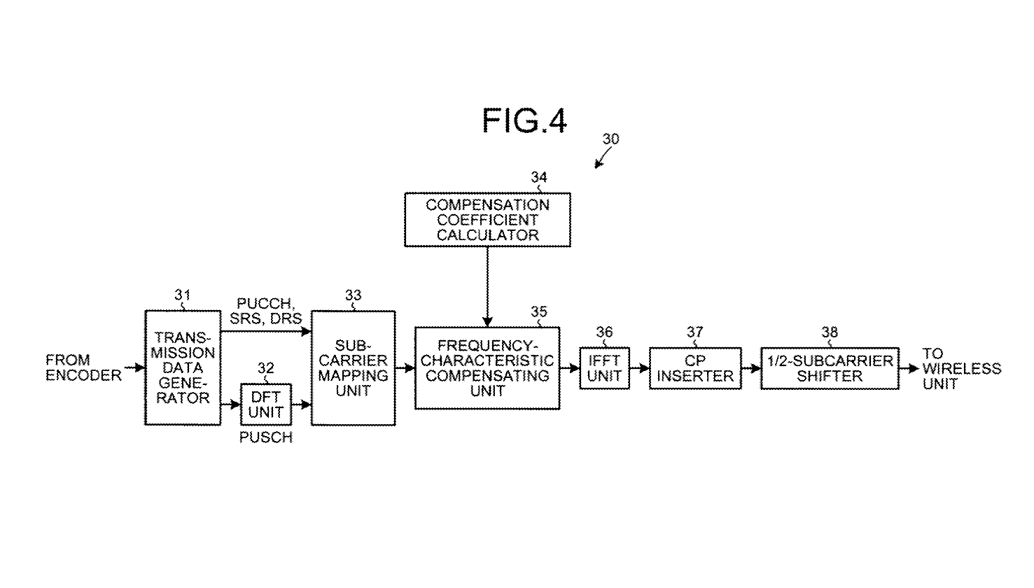

FIG. 4 is a block diagram of the transmission processor of the wireless communications apparatus according to the second embodiment. As depicted in FIG. 4, the transmission processor 30 includes a transmission data generator 31, a discrete Fourier transform (DFT) unit 32, and a subcarrier mapping unit 33.

The transmission data generator 31 generates from the data forwarded from the encoder 29, transmission data for the PUSCH, the PUCCH, the SRS, and the DRS. The DFT unit 32 performs DFT with respect to the PUSCH and converts the PUSCH to a frequency domain signal. The subcarrier mapping unit 33 maps the data (PUCCH, SRS, DRS) output by the transmission data generator 31 and the data (PUSCH) output by the DFT unit 32 to the subcarrier intended for use and outputs the mapped data. The subcarrier mapping unit 33, upon outputting head data, simultaneously outputs a data-head pulse that indicates the head data.

The transmission processor 30 includes a compensation coefficient calculator 34 and a frequency-characteristic compensating unit 35 as an example of the frequency-characteristic compensating apparatus. The compensation coefficient calculator 34, before the wireless communications apparatus 21 begins transmission, calculates a frequency-characteristic compensation coefficient for each subcarrier corresponding to the wireless unit device and the frequency band to be used. The frequency-characteristic compensating unit 35, based on the frequency-characteristic compensation coefficients output by the compensation coefficient calculator 34 and the data-head pulse output by the subcarrier mapping unit 33, performs a frequency-characteristic compensation process with respect to the data output by the subcarrier mapping unit 33. The frequency-characteristic compensating unit 35 will be described in detail hereinafter.

The transmission processor 30 includes an inverse fast Fourier transform (IFFT) unit 36, a cyclic prefix (CP) inserter 37, and a ½-subcarrier shifter 38. The IFFT unit 36 performs, for example, 2048-point IFFT with respect to the data output by the frequency-characteristic compensating unit 35 and further converts the data to a time domain signal. The CP inserter 37 inserts a cyclic prefix into the data output by the IFFT unit 36. The ½-subcarrier shifter 38 performs a ½-subcarrier shift process on the data output by the CP inserter 37. The data output by the ½-subcarrier shifter 38 is sent to the wireless unit 24.

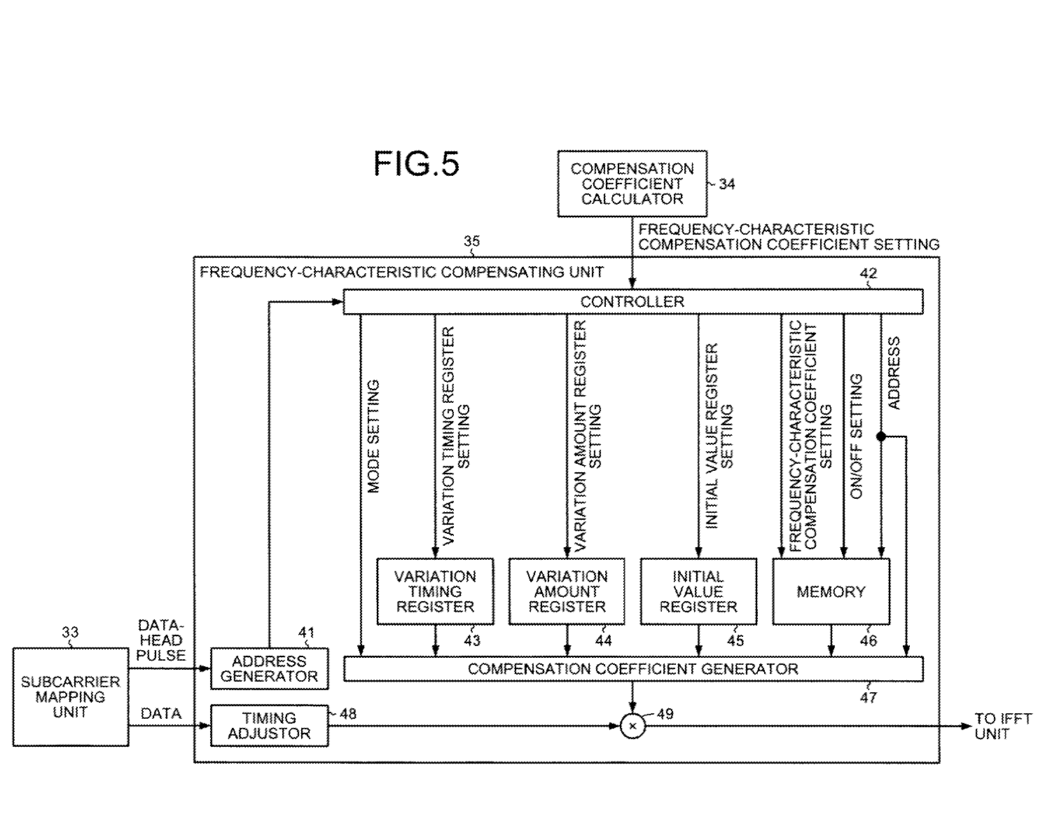

FIG. 5 is a block diagram of the frequency-characteristic compensating unit of the wireless communications apparatus according to the second embodiment. As depicted in FIG. 5, the frequency-characteristic compensating unit 35 includes an address generator 41, a controller 42, a variation timing register 43, a variation amount register 44, an initial value register 45, memory 46, and for example as the frequency-characteristic compensating unit, a compensation coefficient generator 47, a timing adjustor 48, and a multiplier 49 as an output unit.

The address generator 41, upon receiving input of the data-head pulse output by the subcarrier mapping unit 33, begins address generation. The address generator 41 sets the head of the address to be generated to 0 and increments the address by 1 at each clock. The address generator 41 suspends operation after the address has been incremented for each data output by the subcarrier mapping unit 33.

The controller 42, based on the address output by the address generator 41 and the frequency-characteristic compensation coefficients output by the compensation coefficient calculator 34, generates an initial value, a variation amount, and a variation timing for each frequency-characteristic compensation coefficient, and determines the frequency-characteristic compensation process mode. The controller 42 sets each initial value of the frequency-characteristic compensation coefficients in the initial value register 45, sets each variation amount of the frequency-characteristic compensation coefficients in the variation amount register 44, and sets each variation timing of the frequency-characteristic compensation coefficients in the variation timing register 43. The controller 42 stores to the memory 46, with respect to the address output by the address generator 41, the frequency-characteristic compensation coefficient for each subcarrier, output by the compensation coefficient calculator 34. The controller 42 controls the ON/OFF setting of the power to the memory 46. The controller 42 sets in the compensation coefficient generator 47, the frequency-characteristic compensation process mode and the address output by the address generator 41. The controller 42 will be described in detail hereinafter.

The initial value register 45 holds the initial value of a frequency-characteristic compensation coefficient set by the controller 42. The variation amount register 44 holds variation amount of a frequency-characteristic compensation coefficient set by the controller 42. The variation timing register 43 holds the variation timing of a frequency-characteristic compensation coefficient set by the controller 42. The memory 46 stores the frequency-characteristic compensation coefficient for each subcarrier, stored thereto by the controller 42. The ON/OFF setting of power to the memory 46 is controlled by the controller 42.

The compensation coefficient generator 47 uses the initial value, the variation amount, and the variation timing of a frequency-characteristic compensation coefficient held in the initial value register 45, the variation amount register 44, and the variation timing register 43 and generates a compensation coefficient, respectively. The compensation coefficient generator 47 changes the compensation coefficient generation method, based on the frequency-characteristic compensation process mode set by the controller 42 and the address output by the controller 42. The compensation coefficient generator 47 will be described in detail hereinafter.

The timing adjustor 48 adjusts the timing of the data output by the subcarrier mapping unit 33. For example, the timing adjustor 48 delays the timing at which data is supplied to the multiplier 49, by the period required for the address generation process by the address generator 41 and the compensation coefficient generation process by the compensation coefficient generator 47. As a result, at the multiplier 49, the phase of the data output by the timing adjustor 48 and the phase of the compensation coefficient output by the compensation coefficient generator 47 become in-phase. A terminal (not depicted) used when the data output by the subcarrier mapping unit 33 is input to the timing adjustor 48 is an example of the subcarrier-signal input unit.

The multiplier 49 multiplies the data output by the timing adjustor 48 by the compensation coefficient output by the compensation coefficient generator 47 and compensates the frequency characteristic. The frequency-characteristic compensated signal output by the multiplier 49 is sent to the IFFT unit 36. A frequency-characteristic compensated subcarrier signal at the multiplier 49 may be given as an example of a frequency-characteristic compensated signal. Alternatively, a group of frequency-characteristic compensated subcarrier signals that have been converted to time domain signals by IFFT at the IFFT unit 36 may be given as an example of a frequency-characteristic compensated signal.

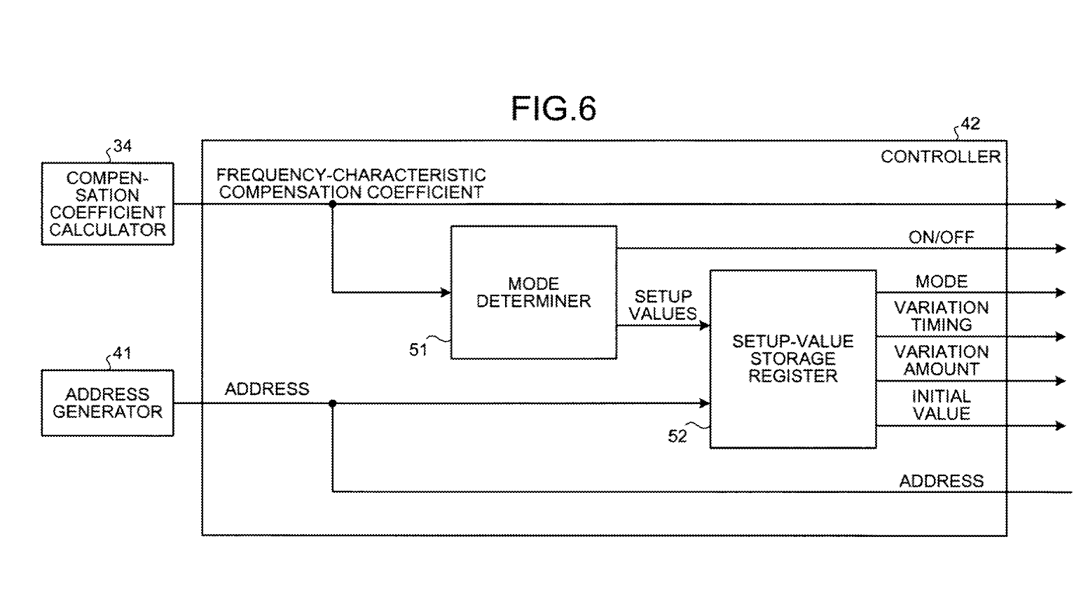

FIG. 6 is a block diagram of the controller of the wireless communications apparatus according to the second embodiment. As depicted in FIG. 6, the controller 42 includes, for example, a mode determiner 51 as the operation category selector and a setup-value storage register 52 as the setup-value storage.

The mode determiner 51, when the frequency-characteristic compensation coefficient for each subcarrier, output by the compensation coefficient calculator 34 is stored to the memory 46, looks up the variation amount of the frequency-characteristic compensation coefficient for each subcarrier and based on the result, determines the mode. The mode determiner 51 forwards, as a mode determination result, to the setup-value storage register 52, for example, the mode, and the initial value, the variation amount and the variation timing of the frequency-characteristic compensation coefficient that corresponds to the mode. The mode determiner 51 outputs a signal that controls the power (on/off) to the memory 46, based on the mode determination. The mode determiner 51, for example, includes a logic circuit that generates a mode that corresponds to the frequency-characteristic compensation coefficient of each subcarrier output by the compensation coefficient calculator 34, and that further generates the initial value, the variation amount, and the variation timing each frequency-characteristic compensation coefficient corresponding to the mode.

The mode, for example, may include the following modes 1 to 5. For example, mode 1 is a case where the value of the frequency-characteristic compensation coefficient is constant irrespective of subcarrier. Mode 2 is a case where the variation amount of the frequency-characteristic compensation coefficient for each subcarrier is constant. Mode 3 is a case where the frequency-characteristic compensation coefficients vary by a constant amount, at constant subcarrier intervals. Mode 4 is a combination of any two or more modes among modes 1, 2, and 3. Mode 5 is a case where the variation amount and the variation timing of the frequency-characteristic compensation coefficients are constant.

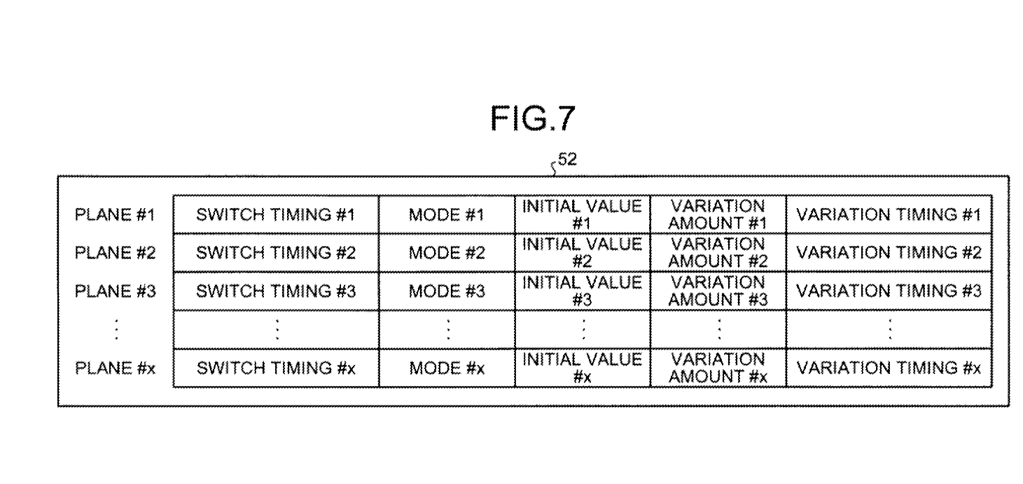

The setup-value storage register 52 holds, for example, the address output by the address generator 41, and the mode as well as the initial value, the variation amount and the variation timing of the frequency-characteristic compensation coefficients output by the mode determiner 51. The setup-value storage register 52 outputs the mode, as well as the initial value, the variation amount and the variation timing of the frequency-characteristic compensation coefficients held therein. FIG. 7 depicts an example of the configuration of the setup-value storage register 52.

FIG. 7 is a diagram of the setup-value storage register of the wireless communications apparatus according to the second embodiment. As depicted in FIG. 7, the setup-value storage register 52 has multiple planes (plane#1, . . . , plane#x) that each have areas storing switch timing, mode, and the initial value, variation amount and variation timing of the frequency-characteristic compensation coefficients, respectively. For example, the switch timing is an example of a category condition used in determining whether to select an operation category in the frequency-characteristic compensation. In the head plane of the setup-value storage register 52, for example, in the area of plane#1 storing the switch timing, 0 may stored as the address indicating the timing at which the frequency-characteristic compensation using the values set in plane#1 starts.

Further, a mode maybe given as example of an operation category indicating the type of handling of a compensation coefficient in frequency-characteristic compensation. The initial value of the frequency-characteristic compensation coefficient may be given as an example of a compensation coefficient used in the frequency-characteristic compensation of a subcarrier signal. The variation amount of the frequency-characteristic compensation coefficient may be included as a compensation coefficient used in the frequency-characteristic compensation of a subcarrier signal.

For example, in the case of mode 1, in a plane (e.g., plane#1) of the setup-value storage register 52, 1 is set in the area storing the mode. Since the value of the frequency-characteristic compensation coefficient is constant, there is one frequency-characteristic compensation coefficient value. Accordingly, this frequency-characteristic compensation coefficient value is set in the same plane (e.g., plane#1), in the area storing the initial value. Zero (“0”) is set in the same plane (e.g., plane#1), in the area storing the variation amount. Since the variation amount of the frequency-characteristic compensation coefficient is 0, the value of the frequency-characteristic compensation coefficient for each subcarrier is the same. An arbitrary value is set in the same plane (e.g., plane#1), in the area storing the variation timing. When each of the setup values are set in the setup-value storage register 52 at mode 1, for example, power to the memory 46 may be turned off.

Further, for example, in the case of mode 2, in a plane (e.g., plane#1) in the setup-value storage register 52, 2 is set in the area storing the mode. Since the value of the variation amount of the frequency-characteristic compensation coefficient for each subcarrier is constant, the initial value of the frequency-characteristic compensation coefficient is set in the same plane (e.g., plane#1), in the area storing the initial value. The variation amount of the compensation coefficient for each subcarrier is set in the same plane (e.g., plane#1), in the area storing the variation amount. One (“1”) is set in the same plane (e.g., plane#1), in the area storing the variation timing. Since the variation timing of the frequency-characteristic compensation coefficient is 1, for each subcarrier, the value of the frequency-characteristic compensation coefficient differs by the variation amount. When each of the setup values are set in the setup-value storage register 52 at mode 2, for example, power to the memory 46 may be turned off.

In the case of mode 3, in a plane (e.g., plane#1) of the setup-value storage register 52, 3 is set in the area storing the mode. Since the frequency-characteristic compensation coefficient varies by a constant amount at constant subcarrier intervals, the initial value of the frequency-characteristic compensation coefficient is set in the same plane (e.g., plane#1), in the area storing the initial value. The variation amount of the compensation coefficient for each subcarrier is set in the same plane (e.g., plane#1), in the area storing the variation amount. The interval at which the compensation coefficient varies (if variation occurs every k subcarriers, k≠1) is stored in the same place (e.g., plane#1), in the area storing the variation timing. Since the variation timing of the frequency-characteristic compensation coefficient is, for example, k, the value of the frequency-characteristic compensation coefficient every k subcarriers varies by variation amount each time. When each of the setup values are set in the setup-value storage register 52 at mode 3, for example, power to the memory 46 may be turned off.

In the case of mode 4, since multiple modes are combined, values are set in planes of a quantity corresponding to the quantity of modes combined (e.g., in the case of modes 1 to 3, plane#1, plane#2, and plane#3). The address of the timing at which a mode switches is stored in each plane (e.g., plane#1, plane#2, and plane#3), in the area storing the switch time. In each of the planes (e.g., plane#1, plane#2, and plane#3), the area storing the mode, the area storing the initial value, the area storing the variation amount, and the area storing the variation timing are respectively set with a value corresponding to the mode.

When the address output by the address generator 41 coincides with an address set in the area storing the switch timing in one of the planes, the setup-value storage register 52 outputs the mode and the initial value, the variation amount and the variation timing of the frequency-characteristic compensation coefficient stored in the plane. When all of the subcarriers used in the frequency band used have one mode, values are set in only one plane (e.g., plane#1) of the setup-value storage register 52. The setup-value storage register 52 outputs the mode and the initial value, the variation amount and the variation timing of the frequency-characteristic compensation coefficient stored in the plane.

The mode is output to the compensation coefficient generator 47. The initial value of the frequency-characteristic compensation coefficient is output to the initial value register 45. The variation amount of the frequency-characteristic compensation coefficient is output to the variation amount register 44. The variation timing of the frequency-characteristic compensation coefficient is output to the variation timing register 43. Since mode 4, which is a combination of modes 1 and 2, can implement mode 3, mode 3 may be omitted.

In the case of mode 5, in a plane (e.g., plane#1) of the setup-value storage register 52, 5 is set in the area storing the mode. Since the variation amount and the variation timing of the frequency-characteristic compensation coefficients differs, the frequency-characteristic compensation coefficient for each subcarrier is held in the memory 46. In this case, power to the memory 46 is on. No values are set in other areas of the setup-value storage register 52.

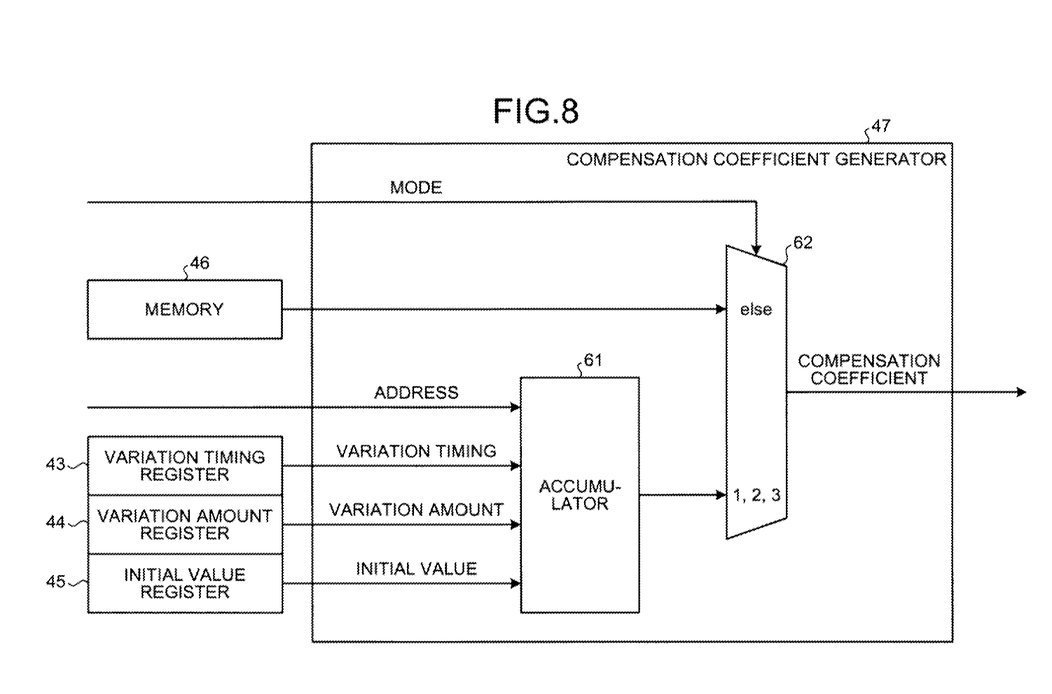

FIG. 8 is a block diagram of the compensation coefficient generator of the wireless communications apparatus according to the second embodiment. As depicted in FIG. 8, the compensation coefficient generator 47 includes an accumulator 61 and a selector 62. The accumulator 61 multiplies the initial value of the frequency-characteristic compensation coefficient output by the initial value register 45 and the variation amount of the frequency-characteristic compensation coefficient output by the variation amount register 44, and generates a compensation coefficient. The timing of the multiplication is when the address generated by the address generator 41 and input to the accumulator 61 has been incremented by an amount equivalent to the variation timing of the frequency-characteristic compensation coefficient output by the variation timing register 43.

The selector 62 selects and outputs either the compensation coefficient output by the accumulator 61 or the compensation coefficient output from the memory 46, according to the mode output by the setup-value storage register 52. For example, when the mode is 1, 2, or 3, the selector 62 selects the compensation coefficient from the accumulator 61, while for other modes (e.g., mode 5), the selector 62 selects the compensation coefficient output from the memory 46.

For example, in the case of mode 1, 0 is held in the variation amount register 44. Accordingly, for all of the subcarriers used in the frequency band used, the compensation coefficient generator 47 outputs from the selector 62 as the compensation coefficient, the value held in the initial value register 45. Under mode 1, when the compensation coefficient is generated and the data output by the timing adjustor 48 is multiplied by the compensation coefficient at the multiplier 49, for example, power to the memory 46 may be turned off.

In the case of mode 2, 1 is held in the variation timing register 43. Accordingly, for the first subcarrier, the compensation coefficient generator 47 outputs from the selector 62 as the compensation coefficient, the value held in the initial value register 45. For the 2nd and subsequent subcarriers, the compensation coefficient generator 47 adds the compensation coefficient for the previous subcarrier and the value held in the variation amount register 44, and outputs the result from the selector 62, as the compensation coefficient. Under mode 2, when the compensation coefficient is generated and the data output by the timing adjustor 48 is multiplied by the compensation coefficient at the multiplier 49, for example, power to the memory 46 may be turned off.

In the case of mode 3, for example, k is held in the variation timing register 43. Accordingly, the compensation coefficient generator 47 outputs the value held in the initial value register 45 from the selector 62, as the compensation coefficient for a group of subcarriers from the first to the k-th subcarriers. The compensation coefficient generator 47 adds the value held in the variation amount register 44 to the compensation coefficient for the previous group of k subcarriers and outputs the result from the selector 62, as the compensation coefficient for the next group of k subcarriers. When the compensation coefficient is generated at mode 3, and the data output by the timing adjustor 48 and the compensation coefficient are multiplied by the multiplier 49, for example, power to the memory 46 may be turned off.

In the case of mode 4, two or more modes among modes 1, 2, and 3 are combined. In the case of mode 5, the compensation coefficient generator 47, based on the address generated by the address generator 41, reads out from the memory 46, a compensation coefficient for each subcarrier and outputs the compensation coefficients from selector 62. In this case, power to the memory 46 is on.

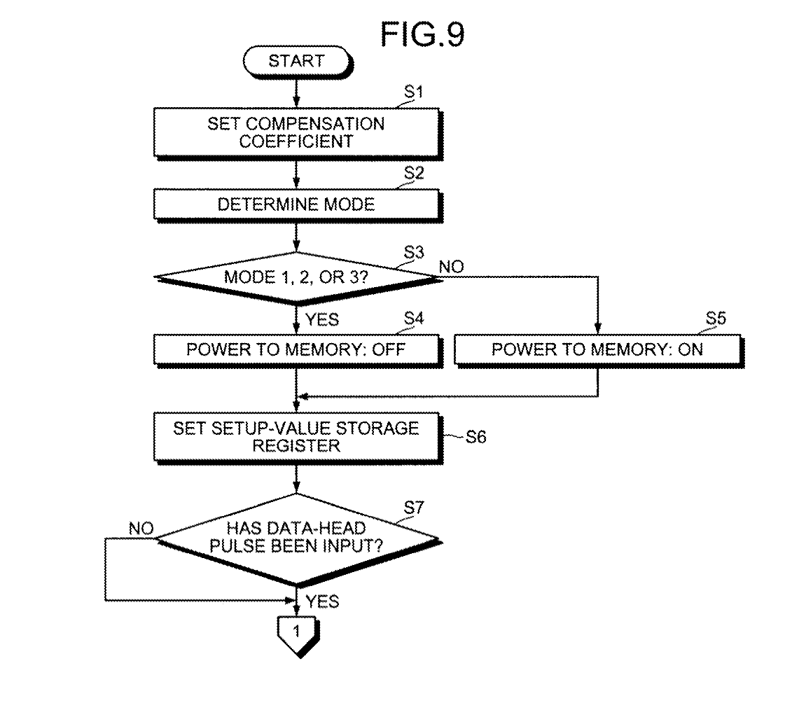

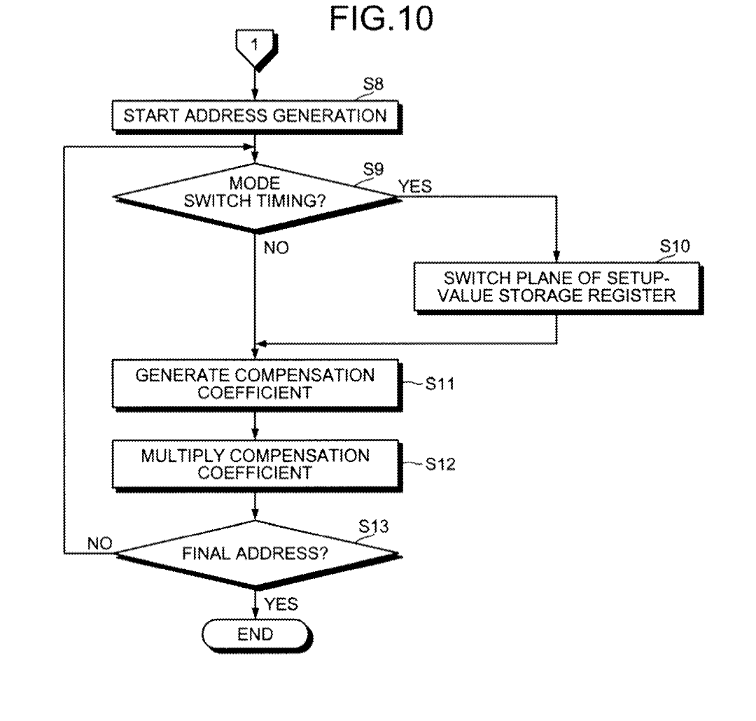

FIGS. 9 and 10 are flowcharts of a process performed by the frequency-characteristic compensating unit of the wireless communications apparatus according to the second embodiment. As depicted in FIG. 9, when the process by the frequency-characteristic compensating unit 35 begins, the frequency-characteristic compensation coefficient calculated for each subcarrier by the compensation coefficient calculator 34 are set in the controller 42 (step S1). The mode determiner 51 determines the mode, based on the set frequency-characteristic compensation coefficient (step S2).

If the mode determiner 51 determines the mode to be mode 1, 2, or 3 (step S3: YES), the mode determiner 51 turns off the power to the memory 46 (step S4). On the other hand, if the mode is determined to be a mode other than mode 1, 2, or 3 (step S3: NO), the mode determiner 51 turns the power to the memory 46 on (step S5). When the power to the memory 46 is turned on, the frequency-characteristic compensation coefficients calculated by the compensation coefficient calculator 34 are stored to the memory 46.

The mode determiner 51, after controlling the power to the memory 46, sets the values of the switch timing, the mode, and the initial value, the variation amount, and the variation timing of the frequency-characteristic compensation coefficient in the setup-value storage register 52 (step S6). The address generator 41 awaits input of the data-head pulse from the subcarrier mapping unit 33 (step S7: NO).

When the data-head pulse is input to the address generator 41 (step S7: YES), as depicted in FIG. 10, the address generator 41 begins address generation (step S8). The controller 42, when the address input from the address generator 41 coincides with the switch timing in any one of the planes in the setup-value storage register 52 (step S9: YES), switches the plane of the setup-value storage register 52 to the plane having the switch timing to which the address coincides (step S10). When the address does not coincide with the switch timing in any of the planes of the setup-value storage register 52 (step S9: NO), the controller 42 does not switch the plane of the setup-value storage register 52.

The accumulator 61 generates a compensation coefficient, based on the address input from the address generator 41, the initial value held in the initial value register 45, the variation amount held in the variation amount register 44, and the variation timing held in the variation timing register 43 (step S11). The selector 62, according to the mode output by the setup-value storage register 52, selects either the compensation coefficient output by the accumulator 61 or the compensation coefficient output from the memory 46.

The multiplier 49 multiplies the data output from the timing adjustor 48 by the compensation coefficient output from the compensation coefficient generator 47 (step S12). The frequency-characteristic compensating unit 35, until the address generated at step S8 becomes the final address (step S13: NO), repeats the operations at steps S9 to S13, and when the address generated at step S8 becomes the final address (step S13: YES), ends the series of operations.

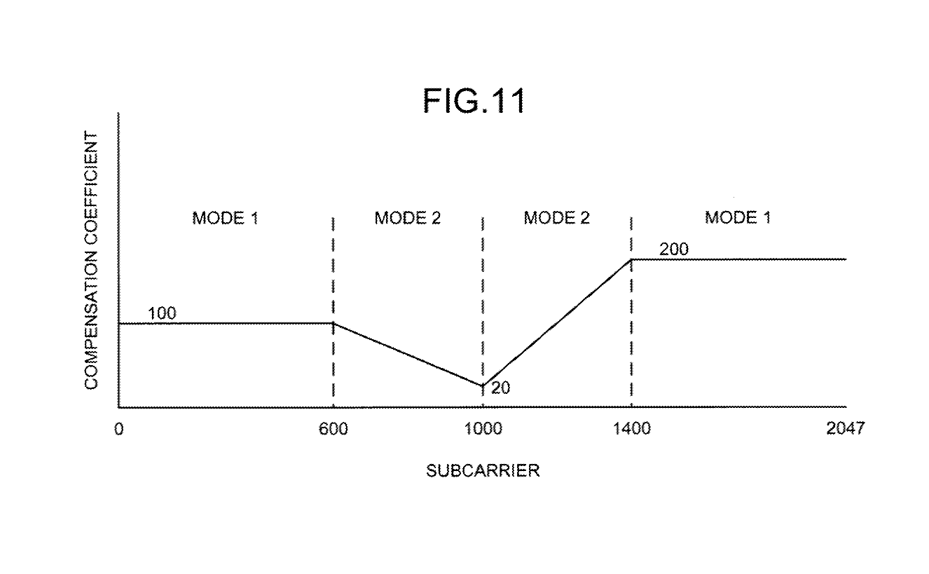

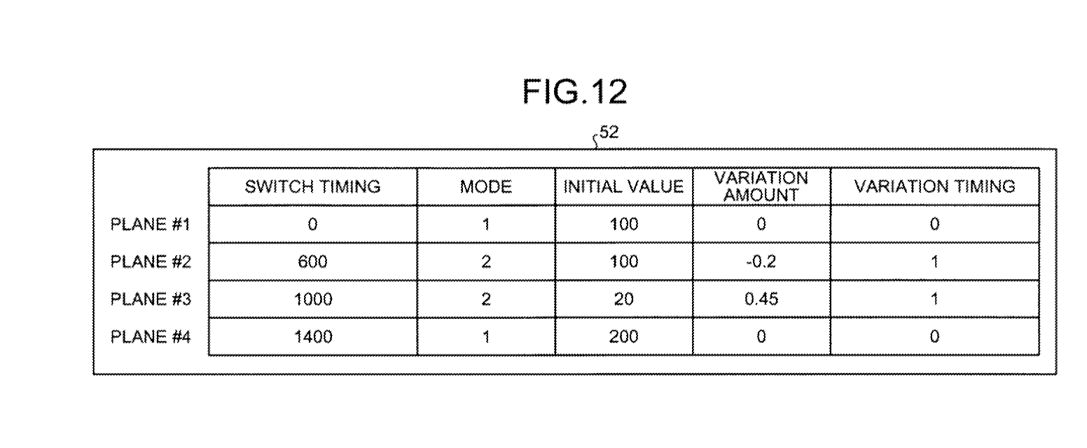

FIG. 11 is a diagram of an example of frequency-characteristic compensation coefficients for subcarriers. FIG. 12 is a diagram of an example of the setup-value storage register corresponding to the example depicted in FIG. 11. In this example, the number of subcarriers is assumed to be 2048, and the frequency-characteristic compensation coefficients of the 2048 subcarriers are separated according to four modes.

For 0-th to the 599th subcarriers, the compensation coefficient is constantly 100. Accordingly, the mode determiner 51 determines that the mode is 1 and with respect to plane#1 of the setup-value storage register 52, makes the following settings: switch timing=0, mode=1, initial value=100, variation amount=0, and variation timing=0 (or an arbitrary value).

For the 600th to the 999th subcarriers, the compensation coefficient varies at a constant rate, from 100 to 20 (decreases). Accordingly, the mode determiner 51 determines that the mode is 2 and with respect to plane#2 of the setup-value storage register 52, makes the following settings: switch timing=600, mode=2, initial value=100, variation amount=−0.2, and variation timing=1. The variation amount of −0.2 is yielded by a computation of [(20−100)/(1000−600)].

For the 1000th to the 1399th subcarriers, the compensation coefficient varies at a constant rate from 20 to 200 (increases). Accordingly, the mode determiner 51 determines that the mode is 2 and with respect to plane#3 of the setup-value storage register 52, makes the following settings: switch timing=1000, mode=2, initial value=20, variation amount=0.45(=(20−100)/(1000−600)), and variation timing=1. The variation amount of 0.45 is yielded by computation of [(200−20)/(1400−1000)].

For the 1400th to the 2047the subcarriers, the compensation coefficient is constant at 200. Accordingly, the mode determiner 51 determines that the mode is 1 and with respect to plane#4 of the setup-value storage register 52, makes the following settings: switch timing=1400, mode=1, initial value=200, variation amount=0, and variation timing=0 (or an arbitrary value).

At the controller 42, first, the addresses generated by the address generator 41 and the plane#1 switch timing are compared. Since the plane#1 switch timing is 0, the head address coincides with the plane#1 switch timing. Accordingly, the setup-value storage register 52 outputs the values set at plane#1 to the initial value register 45, the variation amount register 44, and the variation timing register 43. Next, the addresses generated by the address generator 41 and the plane#2 switch timing are compared. Since the plane#2 switch timing is 600, the address 600 coincides with the plane#2 switch timing. Accordingly, the setup-value storage register 52 outputs the values set at plane#2 to the initial value register 45, the variation amount register 44, and the variation timing register 43. Similarly, the setup-value storage register 52, at the address 1000, outputs the values set at plane#3; and at the address 1400, outputs the values set at plane#4.

According to the second embodiment, for example, in the case of modes 1 to 4, power to the memory 46 may be turned off. That is, compared to keeping the power to the memory 46 turned on to hold the compensation coefficients for all of the subcarriers used in the frequency band used, and reading out from the memory 46, the compensation coefficients according to subcarrier, the power consumed by the memory can be reduced. Accordingly, power consumption of the wireless communications apparatus can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communications apparatus that performs frequency-characteristic compensation with respect to a subcarrier signal that results from separating frequency components from a multicarrier modulated signal, the wireless communications apparatus comprising:
a setup-value storage that stores therein setup information that includes a compensation coefficient that is used in the frequency-characteristic compensation of the subcarrier signal, an operation category indicating the type of handling of the compensation coefficient in the frequency-characteristic compensation, and a category condition used in determining whether to select the operation category in the frequency-characteristic compensation;
a subcarrier-signal input unit that receives input of the subcarrier signal;
an address generator that in conjunction with the input timing of the subcarrier signal, generates an address that corresponds to the subcarrier signal;
an operation category selector that determines a category condition, which is a condition that the generated address satisfies, and selects the operation category that corresponds to the category condition;
a frequency-characteristic compensating unit uses the compensation coefficient that corresponds to the selected operation category in a frequency-characteristic compensation process for the selected operation category and performs the frequency-characteristic compensation on the input subcarrier signal; and
an output unit that outputs the frequency-characteristic compensated signal.

2. The wireless communications apparatus according to claim 1, wherein the setup-value storage includes registers storing therein the compensation coefficient, the operation category, and the category condition.

3. The wireless communications apparatus according to claim 1, wherein
the compensation coefficient includes an initial value and a variation amount, and
the frequency-characteristic compensating unit uses a value that is a sum of the initial value and the variation amount, and performs the frequency-characteristic compensation on each input subcarrier signal.

4. The wireless communications apparatus according to claim 1, further comprising:
a memory that stores for each input subcarrier signal, a compensation coefficient that is used in the frequency-characteristic compensation, wherein power to the memory is turned off according to the selected operation category.

5. A frequency-characteristic compensating apparatus that performs frequency-characteristic compensation with respect to a subcarrier signal that results from separating frequency components from a multicarrier modulated signal, the frequency-characteristic compensating apparatus comprising:
a setup-value storage that stores therein setup information that includes a compensation coefficient that is used in frequency-characteristic compensation of the subcarrier signal, an operation category indicating the type of handling of the compensation coefficient in the frequency-characteristic compensation, and a category condition used in determining whether to select the operation category in the frequency-characteristic compensation;
a subcarrier-signal input unit that receives input of the subcarrier signal;
an address generator that in conjunction with the input timing of the subcarrier signal, generates an address that corresponds to the subcarrier signal;
an operation category selector that determines a category condition, which is a condition that the generated address satisfies, and selects the operation category that corresponds to the category condition;
a frequency-characteristic compensating unit uses the compensation coefficient that corresponds to the selected operation category in a frequency-characteristic compensation process for the selected operation category and performs the frequency-characteristic compensation on the input subcarrier signal; and
an output unit that outputs the frequency-characteristic compensated signal.
